(19) United States
(12) Patent Application Publication
(10) Pub. No.: US 2025/0393006 A1
(43) Pub. Date: Dec. 25, 2025

(54) FLEXIBLE RECOVERY FROM REGISTRATION PROCEDURE FAILURE

(71) Applicant: QUALCOMM Incorporated, San Diego, CA (US)

(72) Inventors: Miguel GRIOT, La Jolla, CA (US); Gavin Bernard HORN, La Jolla, CA (US)

(21) Appl. No.: 18/751,566

(22) Filed: Jun. 24, 2024

(51) Int. Cl. H04W 60/00

(52) U.S. Cl. CPC H04W 60/00

(57) ABSTRACT

Methods, systems, and devices for wireless communications are described. A user equipment (UE) may transmit a registration request to a network entity that requests registration of the UE on a wireless network associated with the network entity. The UE may detect a registration failure associated with the registration request, the registration failure being associated with a condition associated with the UE. The UE may transmit a set of registration request retry messages based at least in part on the registration failure, wherein at least one of a quantity of registration request retry messages in the set of registration request retry messages or a duration between transmissions within the set of registration request retry messages is based at least in part on the condition associated with the UE.

### FIELD OF TECHNOLOGY

The following relates to wireless communications, including flexible recovery from registration procedure failure.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

Wireless networks may support registration procedures allowing a user equipment (UE) to connect to the wireless network. The registration procedure may include the UE transmitting a registration request to the network and the network responding with a registration accept message. However, in some cases the registration procedure may fail (e.g., due to a variety of reasons). In some networks, a quantity of registration retry attempts that the UE is allowed to make and a duration of time between registration retry attempts may be fixed. Additionally, when the allowed quantity of registration retry attempts are also unsuccessful, a duration of time before which the UE can attempt another registration procedure may also be fixed. However, in some cases, such fixed time durations or quantities of registration retry attempts may be inefficient or ineffective for the UE.

Accordingly, aspects of the techniques described herein provide for the UE to select the time durations and the quantity of registration retry attempts based on conditions observed by or otherwise associated with the UE. For example, the UE may transmit or otherwise convey a registration request to the network that request registration of the UE on the wireless network. The UE may identify or otherwise detect a registration failure associated with the registration request. For example, the UE may receive a registration reject message or may not receive any response to the registration request. In some aspects, the registration failure may be associated with a condition associated with the UE. Accordingly, the UE may transmit a set of registration request retry messages based on the registration failure. However, the quantity of registration request retry messages, the duration between transmissions within the set of registration request retry messages, the duration between sets of registration retry messages, or any combination thereof, may be selected or otherwise identified by the UE based at least in part on the condition associated with the UE.

A method for wireless communications by a user equipment (UE) is described. The method may include transmitting a registration request to a network entity that requests registration of the UE on a wireless network associated with the network entity, detecting a registration failure associated with the registration request, the registration failure being associated with a condition associated with the UE, and transmitting a set of registration request retry messages based on the registration failure, where at least one of a quantity of registration request retry messages in the set of registration request retry messages or a duration between transmissions within the set of registration request retry messages is based on the condition associated with the UE.

A UE for wireless communications is described. The UE may include one or more memories storing processor executable code, and one or more processors coupled with the one or more memories. The one or more processors may individually or collectively be operable to execute the code to cause the UE to transmit a registration request to a network entity that requests registration of the UE on a wireless network associated with the network entity, detect a registration failure associated with the registration request, the registration failure being associated with a condition associated with the UE, and transmit a set of registration request retry messages based on the registration failure, where at least one of a quantity of registration request retry messages in the set of registration request retry messages or a duration between transmissions within the set of registration request retry messages is based on the condition associated with the UE.

Another UE for wireless communications is described. The UE may include means for transmitting a registration request to a network entity that requests registration of the UE on a wireless network associated with the network entity, means for detecting a registration failure associated with the registration request, the registration failure being associated with a condition associated with the UE, and means for transmitting a set of registration request retry messages based on the registration failure, where at least one of a quantity of registration request retry messages in the set of registration request retry messages or a duration between transmissions within the set of registration request retry messages is based on the condition associated with the UE.

A non-transitory computer-readable medium storing code for wireless communications is described. The code may include instructions executable by one or more processors to transmit a registration request to a network entity that requests registration of the UE on a wireless network associated with the network entity, detect a registration failure associated with the registration request, the registration failure being associated with a condition associated with the UE, and transmit a set of registration request retry messages based on the registration failure, where at least one of a quantity of registration request retry messages in the set of registration request retry messages or a duration between transmissions within the set of registration request retry messages is based on the condition associated with the UE.

Some examples of the method, UEs, and non-transitory computer-readable medium described herein may further include operations, features, means, or instructions for starting a new registration procedure based on a second duration relative to transmission of a last registration request retry message in the set of registration request retry messages, where the second duration may be based on the condition associated with the UE.

Some examples of the method, UEs, and non-transitory computer-readable medium described herein may further include operations, features, means, or instructions for receiving a configuration message identifying a range of second durations, where the second duration may be selected by the UE from within the range of second durations.

Some examples of the method, UEs, and non-transitory computer-readable medium described herein may further include operations, features, means, or instructions for receiving a configuration message identifying at least one of a range of quantities of the registration request retry messages or a range of durations between transmissions within the set of registration request retry messages, where the quantity of registration retry messages may be selected by the UE from within the range of quantities and the duration between transmissions within the set of registration request retry messages may be selected by the UE from within the range of durations.

In some examples of the method, UEs, and non-transitory computer-readable medium described herein, the configuration message may be associated with at least one of a universal subscriber identity module (USIM), a policy associated with the UE, or a device management parameter.

In some examples of the method, UEs, and non-transitory computer-readable medium described herein, detecting the registration failure may include operations, features, means, or instructions for receiving a registration request reject message within a registration timer duration based on registration request, where the configuration message may be included in the registration request reject message.

In some examples of the method, UEs, and non-transitory computer-readable medium described herein, the configuration message identifies multiple ranges of quantities and multiple ranges of durations, each range in the multiple ranges of quantities and multiple ranges of durations associated with a corresponding condition associated with the UE.

In some examples of the method, UEs, and non-transitory computer-readable medium described herein, the configuration message may be received based on a completion of a security and authentication establishment procedure associated with the UE.

Some examples of the method, UEs, and non-transitory computer-readable medium described herein may further include operations, features, means, or instructions for starting a new registration procedure based on the transmission of the set of registration request retry messages being completed and expiration of a second duration.

In some examples of the method, UEs, and non-transitory computer-readable medium described herein, the condition associated with the UE includes at least one of a type of the UE, a battery status of the UE, a current network condition, a network operator associated with the UE, a tracking area of the UE, a cell identifier of a cell associated with the UE, a location of the UE, a user preference associated with the UE, a data need associated with the UE, a data latency associated with the UE, a radio access technology (RAT) associated with the UE, or a registration area associated with the UE.

In some examples of the method, UEs, and non-transitory computer-readable medium described herein, detecting the registration failure associated with the registration request is further associated with at least one of an artificial intelligence model or a machine learning model associated with the UE.

In some examples of the method, UEs, and non-transitory computer-readable medium described herein, the duration between transmissions within the set of registration request retry messages includes a first duration between a first set of successive transmissions and a second duration between a second set of successive transmissions within the set of registration request retry messages may be different than the first duration.

Some examples of the method, UEs, and non-transitory computer-readable medium described herein may further include operations, features, means, or instructions for ceasing remaining transmissions of the set of registration request retry messages based on at least one of a different network operator becoming available for a registration procedure with the UE or an emergency service requirement associated with the UE.

Some examples of the method, UEs, and non-transitory computer-readable medium described herein may further include operations, features, means, or instructions for resetting the quantity of registration request retry messages based on at least one of a different network operator becoming available for a registration procedure with the UE or an emergency service requirement associated with the UE.

In some examples of the method, UEs, and non-transitory computer-readable medium described herein, detecting the registration failure may include operations, features, means, or instructions for receiving a registration request reject message within a registration timer duration based on the registration request.

In some examples of the method, UEs, and non-transitory computer-readable medium described herein, detecting the registration failure may include operations, features, means, or instructions for detecting a failure to receive a registration request reject message within a registration timer duration based on the registration request.

In some examples of the method, UEs, and non-transitory computer-readable medium described herein, detecting the registration failure may include operations, features, means, or instructions for receiving a radio resource control (RRC) message identifying a failure to register the UE according to the registration request.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports flexible recovery from registration procedure failure in accordance with one or more aspects of the present disclosure.

FIG. 2 shows an example of a registration procedure that supports flexible recovery from registration procedure failure in accordance with one or more aspects of the present disclosure.

FIG. 3 shows an example of a registration procedure that supports flexible recovery from registration procedure failure in accordance with one or more aspects of the present disclosure.

FIG. 4 shows an example of a method that supports flexible recovery from registration procedure failure in accordance with one or more aspects of the present disclosure.

FIG. 5 shows an illustrative block diagram of an example of a machine learning model represented by an artificial neural network (ANN) D that supports flexible recovery from registration procedure failure in accordance with one or more aspects of the present disclosure.

FIGS. 6 and 7 show block diagrams of devices that support flexible recovery from registration procedure failure in accordance with one or more aspects of the present disclosure.

FIG. 8 shows a block diagram of a communications manager that supports flexible recovery from registration procedure failure in accordance with one or more aspects of the present disclosure.

FIG. 9 shows a diagram of a system including a device that supports flexible recovery from registration procedure failure in accordance with one or more aspects of the present disclosure.

FIGS. 10 through 12 show flowcharts illustrating methods that support flexible recovery from registration procedure failure in accordance with one or more aspects of the present disclosure.

### DETAILED DESCRIPTION

Wireless networks may support registration procedures allowing a user equipment (UE) to connect to the wireless network. The registration procedure generally includes the UE transmitting a registration request to the network and the network responding with a registration accept message. However, in some cases the registration procedure may fail (e.g., due to a variety of reasons). For example, the UE may receive a registration reject message or may simply receive no response to the registration request message. In these cases, the network generally (pre) defines fixed time durations (e.g., T3511 timer values) as well as the quantity of registration retry attempts the UE is allowed to make. Moreover, the network may (pre) define a fixed time duration (e.g., a T3502 timer value) before which the UE can attempt another registration procedure when the registration retry attempts were also unsuccessful. However, in some cases the fixed time durations or quantity of registration retry attempts may be inefficient or ineffective for the UE.

Accordingly, aspects of the techniques described herein provide for the UE to select the time durations and the quantity of registration retry attempts based on conditions observed by or otherwise associated with the UE. For example, the UE may transmit or otherwise convey a registration request to the network that request registration of the UE on the wireless network. The UE may identify or otherwise detect a registration failure associated with the registration request. For example, the UE may receive a registration reject message or may not receive any response to the registration request. In some aspects, the registration failure may be associated with a condition associated with the UE. Accordingly, the UE may transmit a set of registration request retry messages based on the registration failure. However, the quantity of registration request retry messages, the duration between transmissions within the set of registration request retry messages, or both, may be selected or otherwise identified by the UE based at least in part on the condition associated with the UE. That is, the UE may select the duration of the T3511 timer (and the T3502 timer) and the quantity of registration retry attempts (e.g., N) based on the condition associated with the UE. In some examples, a range of T3511/T3502 timer values and a range of registration retry attempts may be (pre) configured or otherwise identified by the UE such that the UE selects those values from withing the ranges.

Aspects of the disclosure are initially described in the context of wireless communications systems. Aspects of the disclosure are further illustrated by and described with reference to apparatus diagrams, system diagrams, and flowcharts that relate to flexible recovery from registration procedure failure.

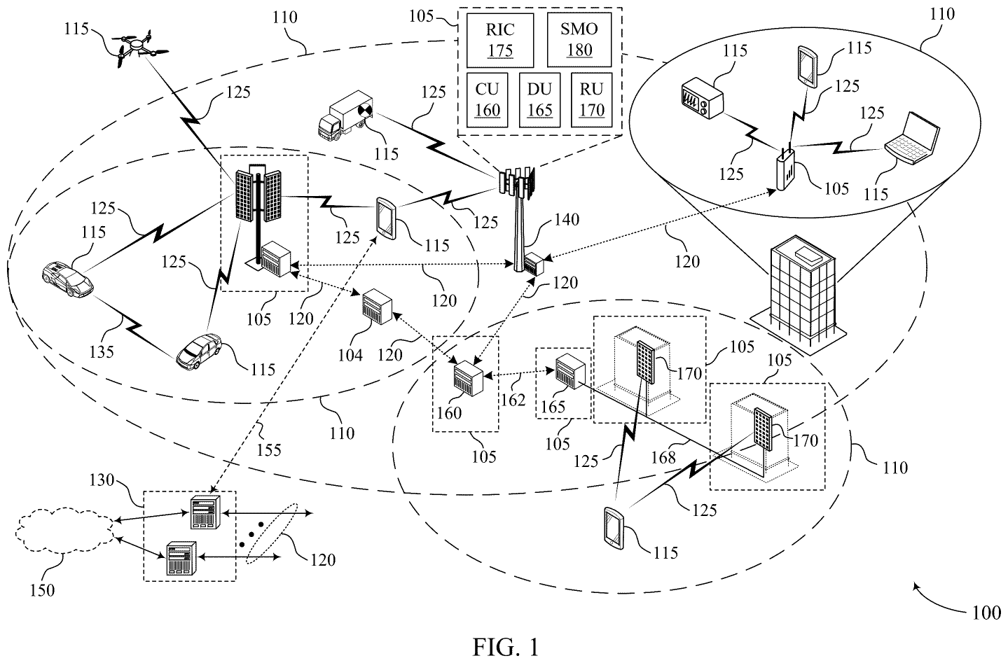

FIG. 1 shows an example of a wireless communications system 100 that supports flexible recovery from registration procedure failure in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may transmit a registration request to a network entity 105 that requests registration of the UE 115 on a wireless network associated with the network entity 105. The UE 115 may detect a registration failure associated with the registration request, the registration failure being associated with a condition associated with the UE 115. The UE 115 may transmit a set of registration request retry messages based at least in part on the registration failure, wherein at least one of a quantity of registration request retry messages in the set of registration request retry messages or a duration between transmissions within the set of registration request retry messages is based at least in part on the condition associated with the UE 115.

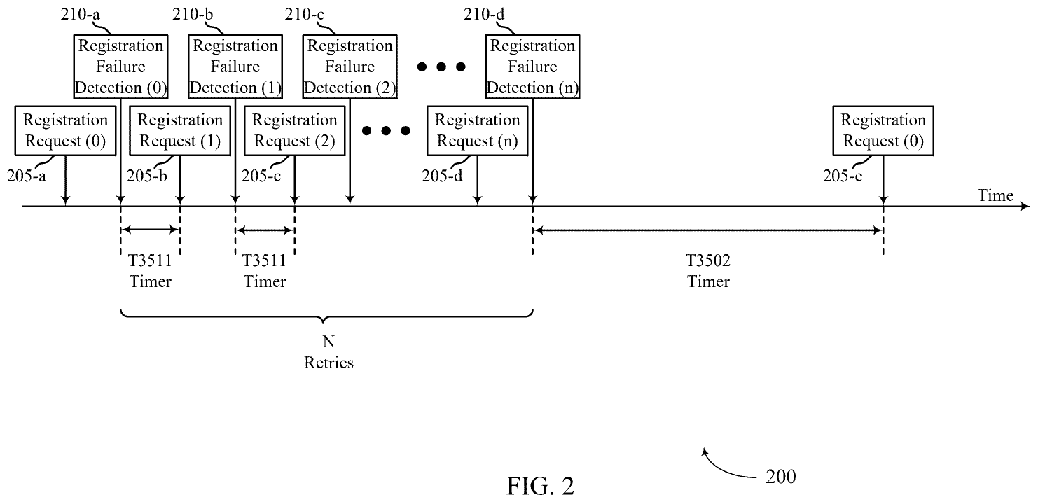

FIG. 2 shows an example of a registration procedure 200 that supports flexible recovery from registration procedure failure in accordance with one or more aspects of the present disclosure. Registration procedure 200 may implement aspects of wireless communications system 100. Aspects of registration procedure 200 may be implemented at or implemented by a UE or a network entity, which may be examples of the corresponding devices described herein.

Wireless networks may utilize registration procedures to register UE on the wireless network. The registration procedure is generally initiated by the UE wishing to register on the network (e.g., to connect to the wireless network for wireless communications). The registration procedure may be initiated by the UE upon initial power on or whenever the UE needs to connect to the core network using a wireless connection (e.g., due to UE mobility or according to a periodic registration update). The registration procedure generally includes an exchange of non-access stratum (NAS) messages between the UE and a network entity associated with a public land mobile network (PLMN).

In some wireless networks, the registration procedure may be initiated when the UE transmits or otherwise outputs a registration request message to the network entity. The UE and network may, based on the registration request message, perform various authentication and security processes as part of the registration procedure. Upon successful completion of the authentication and security process, the network may respond to the UE with a registration accept message. The UE may respond to the registration accept message by transmitting a registration complete message confirming that the UE is registered on the wireless network. However, in some cases the registration request may be denied by the network (e.g., using a registration reject message) or may otherwise fail.

In some aspects, various timers or counters are associated with the NAS message exchanged during the registration procedure. One non-limiting example of such timers are T3510/T3511 timers that is associated with (re) transmissions of the registration request message, if needed. For example, the T3510 timer may be started upon (re) transmission of a registration request message from the UE (e.g., during initial registration, mobility, or for periodic registration update). The T3510 timer may be the duration during which the UE monitors for response NAS messaging from the network entity in response to the registration request message transmission (e.g., such as initiating the security and authentication procedure or receiving the registration accept message). Upon expiration of the T3510 timer and upon detecting a registration failure (e.g., without any response(s) to the registration request message), the UE may initiate a T3511 timer (e.g., a short duration timer) that is associated with retransmission of the registration request message. That is, the T3511 timer may be the duration during which the UE waits to retransmit the registration request message once the UE determines that the initial or retransmission of the registration request message was unsuccessful. Upon expiration of the T3511 timer, the UE may retransmit the registration request message to the network entity to again retry the registration procedure with the wireless network.

In some aspects, a registration attempt counter (N) may be used to limit the quantity of subsequently rejected registration attempts. The UE may increment the registration attempt counter each time a registration request failure has been detected up to a maximum attempt count limit. Once the count limit has been reached, the UE may start a second timer (e.g., a T3502 timer, which is a longer duration timer). That is, T3502 timer may be started at registration failure when the attempt counter has reached its maximum value. Upon expiration of the T3502 timer, the UE may again initiate a new registration procedure with the wireless network, if still required.

In some aspects, the NAS timers used by the UE and the network are either associated with a set of fixed value in the relevant standards or set by the network (usually as defined in the relevant standards). This approach may be helpful in situations where the UE have relatively homogenous capabilities and conditions while the network may have different deployment scenarios or feature support. For example, in some wireless networks the registration procedure retries after failure detection are governed, at least to some degree, by the short retry timer (e.g., the T3511 timer), the registration attempt counter limit, and the long retry timer (e.g., the T3502 timer). As discussed, the T3511 timer may be used to retry registration after failure in the first attempt(s). In some networks, the T3511 timer is set to a fixed value of 10 seconds. The registration attempt counter limit generally identifies the quantity of times the UE retries the registration procedure after failure detection using the short retry timer T3511. In some networks, the registration attempt counter limit is set to a maximum value of five retries. The T3502 timer is used for the next registration procedure retry when the UE has used all the short timer-based retries (e.g., five retries). In some networks, the T3502 timer is set to a default duration of 12 minutes, but may be provided by the network in the registration accept or registration reject messages, in some examples. The short retry timer (e.g., the T3511 timer) and quantity of attempts (e.g., N) are generally standardized such that all failures occur within approximately one minute. After that, the UE backs off for a longer duration (e.g., the T3502 timer duration) as it is assumed a longer duration issue is ongoing.

Aspects of the techniques described herein provide for the UE to be able to select, set or otherwise establish the short timer duration (e.g., the T3511 timer duration), the quantity of retry attempts (e.g., N), and the long timer duration (e.g. the T3502 timer duration) based on condition(s) associated with the UE. Aspects of the described techniques may be used in response to the UE capabilities and scenarios becoming more diverse (e.g., smartphones of different tiers, automotive-based UEs, reduced capability (RedCap) UE, IoT, and other differences). Thus, it may be the UE that can hold more data and logic of the most optimized behavior for itself.

The network (pre) configured values for the T3511 timer, the quantity of retry attempts, and the T3502 timer are arbitrary and do not support adjustment in response to potential scenarios the UE may be aware of (e.g., conditions). However, the techniques described herein provide for the UE to select or otherwise identify these values in response to different scenarios or conditions observed or otherwise known by the UE.

For example, the UE may transmit or otherwise output (and the network entity may receive or otherwise obtain) a registration request 205 that request registration of the UE on a wireless network associated with the network entity. Initially, this may include the UE transmitting a registration request 205-a to the network entity requesting registration of the UE on the wireless network. The UE may start or otherwise initiate a T3510 timer upon transmission of the registration request 205-a. Upon expiration of the T3510 timer, the UE may identify, detect, or otherwise determine a registration failure 210-a associated with the registration request 205-a. In some aspects, the registration failure 210-a may be associated with a condition associated with the UE. The UE may identify, detect, or otherwise determine the registration failure 210-a in any number of mechanisms. For example, the UE may detect the registration failure 210-a based on receiving a registration reject message within a registration timer duration (e.g., during the T3510 timer duration) in response to the registration request 205-a. As another example, the UE may detect the registration failure 210-a based on a failure to receive a registration request reject message within a registration timer duration (e.g., during the T3510 timer duration) in response to the registration request 205-a. As yet another example, the UE may detect the registration failure 210-a based on a RRC message or parameter identifying a failure to register the UE according to the registration request 205-a. That is, the registration failure may be detected at a lower layer of the UE, such as the RRC layer.

Thus, the UE may identify or otherwise determine a condition observed or otherwise detected by the UE that contributes to, at least to some degree, the registration failure. Broadly, the condition associated with the UE may include, but is not limited to, one or more of a type of the UE, a battery status of the UE, a current network condition, a network operator associated with the UE, a tracking area of the UE, a cell identifier of a cell associated with the UE, a location of the UE, a user preference associated with the UE, a data need associated with the UE, a data latency associated with the UE, a RAT associated with the UE, or a registration area associated with the UE. In some aspects, the condition associated with the UE may include, but is not limited to, one or more of an artificial intelligence model or a machine learning model associated with the UE.

Accordingly, the UE may transmit a set of registration request retry messages based on the registration failure. In some aspects, a quantity of registration request retry messages (e.g., the quantity of retry attempts, N) in the set of registration retry messages or a duration between transmissions within the set of registration request retry messages (e.g., the T3511 timer) may be based on the condition associated with the UE. That is, the UE may select or otherwise identify the duration of the T3511 timer as well as the maximum quantity of retry attempts (e.g., N) based on the condition associated with the UE. In some aspects, the quantity of registration request retry messages in the set (e.g., N) may also be selected by the UE based on the condition.

As one non-limiting example of the condition, this may include the UE determining that, based on a low battery status and other data collected from previous registration failures, that faster retries are rarely successful and, therefore, may chose a longer T3511 timer duration. The UE may select or otherwise use a quantity of registration retry messages in the set (e.g., N) based on the battery status of the UE, the time of day, the location of the UE, expected user activity, and other parameters.

In this non-limiting example, the set of registration retry message may include the registration request 205-b, the registration request 205-c, and up to the registration request 205-d. However, also in this non-limiting example each registration request retry message in the set is also associated with a registration failure. For example, the UE may detect a registration failure 210-a in response to the registration request 205-a, a registration failure 210-b in response to the registration request 205-b, a registration failure 210-c in response to the registration request 205-c, and a registration failure 210-d in response to the registration request 205-d. Thus, the UE may transmit each registration request retry message in the set according to the quantity of registration request retry messages (e.g., N) in the set of registration request retry messages.

In response, to this scenario where each registration request retry message is associated with a registration failure, the UE may initiate or otherwise start a new registration procedure based on a second duration relative to the lest registration request retry message in the set (e.g., the T3502 timer). Again, the UE may select or otherwise use a second duration (e.g., the T3502 timer) based on the condition associated with the UE. That is, the UE may start a new registration procedure based on the transmission of the set of registration request retry messages being completed and expiration of the second duration (e.g., the T3502 timer). In some aspects, the UE may start the new registration procedure by transmitting or otherwise outputting a registration request 205-e to the network entity that again requests registration of the UE on the wireless network.

As one non-limiting example, this may include the UE expecting (e.g., given certain conditions and previously collected data on similar conditions), that an abnormal scenario causing the registration failure is usually recovered in less than three minutes. Therefore, the UE may choose a T3502 timer duration of three minutes before starting a new registration procedure. As yet another non-limiting example, this may include the UE determining (e.g., given certain conditions and previously collected data or similar conditions) that an abnormal case either is solved in a few tens of seconds or in several minutes (e.g., two completely different error scenarios that produce similar pre-condition data). Accordingly, the UE may choose to use a short (e.g., aggressive) T3511 timer and a longer T3502 timer.

Thus, aspects of the described techniques provide for the UE to decide, in the case of the registration procedure failure due to, for example, abnormal conditions, the value of the registration retry first (e.g., short) T3511 timer, the value N denoting how many times to retry registration at the expiration of the first retry short timer (e.g., if subsequent registrations fail), and the value of the registration retry second (e.g., long) T3502 timer to be used after the Nth retry to initiate a new registration procedure. The UE may use these values according to, in the case where the registration procedure fails (e.g., due to abnormal conditions), the UE starts the T3511 timer, increments the registration attempt counter and retries the registration procedure at expiration of the T3511 timer. The UE may repeat this if the registration procedure keeps failing up to N times. After the Nth retry, the UE may start the T3502 timer and, upon expiration of the T3502 timer, reset the quantity of retry attempts to zero and initiate a new registration procedure with the network.

The UE may select the value for any of these parameters based on conditions, such as but not limited to, the type of UE (e.g., RedCap UE vs smartphone), the battery status of the UE, the current network conditions, the PLMN, the tracking area the UE is camped in, a cell identifier, a geo-location of the UE, a user preference, an expected current data needs by application layer (e.g., including expected delay tolerance), using artificial intelligence/machine learning (AI/ML) algorithms and modeling, or other conditions observed or otherwise detected by the UE.

In some aspect, the UE may need to stop the registration procedure with the network. For example, while any of the timers (e.g., the T3511 timer or the T3502 timer) are running, the UE may stop the timer and start a new registration procedure. This may include the UE ceasing any remaining transmissions of the set of registration request retry message based on a different network operator becoming available for a registration procedure with the UE or an emergency service requirement associated with the UE. This may include the UE resetting the quantity of registration request retry message based on the different network operator becoming available or the emergency service requirement associated with the UE. For example, the UE may stop the timer(s) and start a new registration if the PLMN selection is triggered for other reasons and the UE selects another (e.g., non-equivalent) PLMN, if the UE is required to connect due to emergency services or prioritized services (e.g., the UE may indicate in the registration request message that the UE is registering for emergency services or prioritized services), or the UE needs to reset the registration attempt counter.

Certain aspects and techniques as described herein may be implemented, at least in part, using an artificial intelligence (AI) program, such as a program that includes a machine learning (ML) or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights.

In some aspects, an ML model may be configured to provide computing capabilities for wireless communications. Such an ML model may be configured with weights and biases to perform registration request 205 quantity determination and the duration between registration request 205 transmissions. Thus, during operation of a device, the ML model may receive input data (such as various data concerning the conditions detected by or otherwise experienced by the UE) and make inferences (such as determining a cause for the registration failure 210, the current network load, the channel performance characteristics or other factors that may contributed to the registration failure 210) based on the weights and biases.

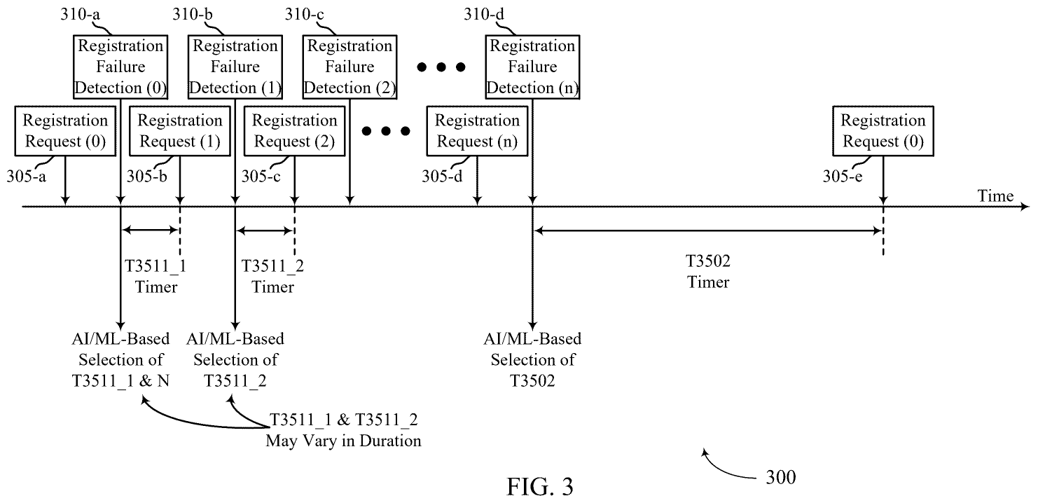

FIG. 3 shows an example of a registration procedure 300 that supports flexible recovery from registration procedure failure in accordance with one or more aspects of the present disclosure. Registration procedure 300 may implement aspects of wireless communications system 100 or aspects of registration procedure 200. Aspects of registration procedure 300 may be implemented at or implemented by a UE or a network entity, which may be examples of the corresponding devices described herein.

As discussed above, aspects of the techniques described herein provide for a UE to select, set, or otherwise determine values for the quantity (N) of registration request retry messages in a set of registration request retry messages, a duration (T3511 timer) between transmissions within the set of registration request retry messages, and a second duration (T3502 timer) relative to the transmission of the last registration request retry message in the set based on a condition observed or detected by the UE or otherwise associated with the UE. For example, the UE may transmit or otherwise output (and the network entity may receive or otherwise obtain) a registration request 305-a that request registration of the UE on a wireless network associated with the network entity. However, the UE may identify, detect, or otherwise determine a registration failure 310-a associated with the registration request 305-a. The registration failure 310-a may be associated with a condition associated with the UE. That is, the UE may determine that the registration failure 310-a has occurred or is otherwise related to the condition associated with the UE.

The UE may transmit a set of registration request retry messages based on the registration failure 310-a. However, the quantity of registration request retry messages in the set or the duration between transmissions within the set may be based o the condition associated with the UE. That is, the UE may select the quantity of registration request retry message (e.g., N), the duration between transmissions within the set of registration request retry messages (e.g., the T3511 timer), as well as the second duration (e.g. the T3502 timer) relative to transmission of a last registration request retry message in the set based on the condition associated with the UE.

In this non-limiting example, the set of registration retry message may include the registration request 305-b, the registration request 305-c, and up to the registration request 305-d. However, also in this non-limiting example each registration request retry message in the set is also associated with a registration failure. For example, the UE may detect a registration failure 310-a in response to the registration request 305-a, a registration failure 310-b in response to the registration request 305-b, a registration failure 310-c in response to the registration request 305-c, and a registration failure 310-d in response to the registration request 305-d. Thus, the UE may transmit each registration request retry message in the set according to the quantity of registration request retry messages (e.g., N) in the set of registration request retry messages.

In response, to this scenario where each registration request retry message is associated with a registration failure, the UE may initiate or otherwise start a new registration procedure based on a second duration relative to the lest registration request retry message in the set (e.g., the T3502 timer). Again, the UE may select or otherwise use a second duration (e.g., the T3502 timer) based on the condition associated with the UE. That is, the UE may start a new registration procedure based on the transmission of the set of registration request retry messages being completed and expiration of the second duration (e.g., the T3502 timer). In some aspects, the UE may start the new registration procedure by transmitting or otherwise outputting a registration request 305-e to the network entity that again requests registration of the UE on the wireless network.

Registration procedure 300 illustrates a non-limiting example where the duration between transmissions within the set of registration request retry messages are different. That is, in some examples the UE may set or otherwise select a T3511 timer values that are different at each retry. For example, the UE may start retransmissions more aggressive at first and then increase the subsequent T3511 timer durations. As one non-limiting example where the UE has selected N to be four (e.g., four retries), the UE may set the first T3511 timer (e.g., T3511_1) duration to four seconds, set the second T3511 timer (e.g., T3511_2) duration to eight seconds, set the third T3511 timer (e.g., T3511_3) duration to twelve seconds, and set the fourth T3511 timer (e.g., T3511_4) duration to sixteen seconds. Accordingly, in some examples, a first duration between a first set of successive transmission may be different than a second duration between a second set of successive transmissions within the set of registration request retry messages.

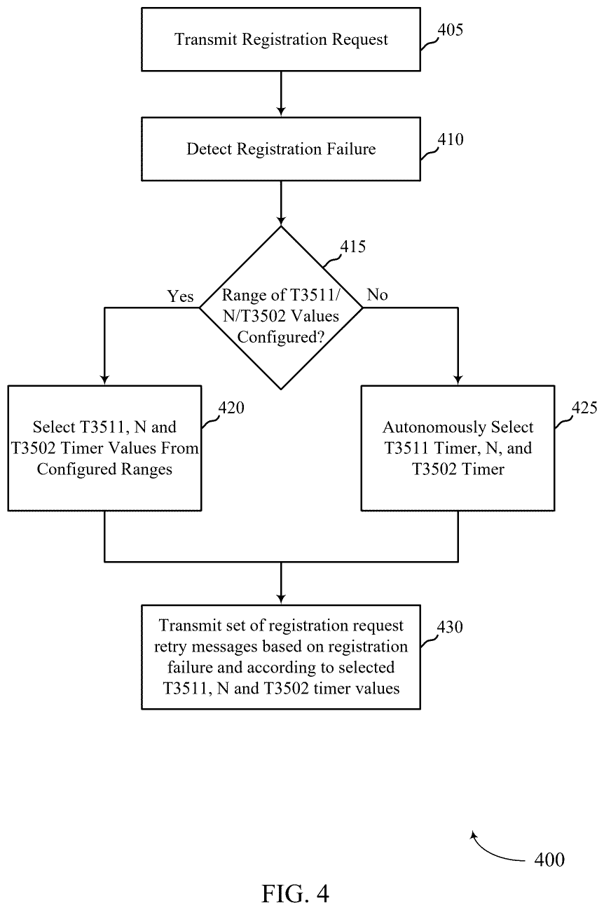

FIG. 4 shows an example of a method 400 that supports flexible recovery from registration procedure failure in accordance with one or more aspects of the present disclosure. Method 400 may implement aspects of wireless communications system 100 or aspects of registration procedure 200 or registration procedure 300. Aspects of method 400 may be implemented at or implemented by a UE or a network entity, which may be examples of the corresponding devices described herein.

At 405, the UE may transmit or otherwise output (and a network entity may optionally receive or otherwise obtain) a registration request that request registration of the UE on a wireless network associated with the network entity. The registration request may be a first step in a UE-initiated registration procedure to register or otherwise connect the UE to the wireless network of the network entity.

At 410, the UE may identify, determine, or otherwise detect a registration failure associated with the registration request. The UE may detect the registration failure based on receiving a registration reject message from the network entity, in some examples. The UE may detect the registration failure based on not receiving the registration reject message from the network entity, in some examples. The UE may detect the registration failure based on not receiving other signaling associated with the registration procedure in response to the registration request (e.g., such as signaling related to or otherwise associated with security and authentication procedures associated with the registration procedure). The UE may detect the registration failure based on lower layer signaling or metrics, such as RRC-based signaling, metrics, or parameters that identify that the registration procedure has failed.

In some aspects, the registration failure may be associated with a condition associated with the UE. That is, the UE may identify or otherwise determine that the registration failure has occurred based on or in response to a condition associated with the UE. The conditions relating to or otherwise associated with the UE may be based on a type of the UE (e.g., RedCap vs non-RedCap UE, IoT device, MTC device, etc.), the current battery status of the UE, a current network condition (e.g., the network load), a network operator (e.g., PLMN) associated with the UE, a tracking area of the UE, a cell identifier of a cell associated with the UE, a location of the UE, a user preference, a data need or latency associated with the UE, an AI/ML model associated with the UE, a RAT associated with the UE, or a registration area associated with the UE.

In some aspects, the condition associated with the UE may provide insights as to the nature of why the registration failure has occurred. For example, the condition may provide an indication of what caused the registration failure, how long the registration procedure is likely to fail, as well as a recommendation regarding resolution of the condition that caused the registration failure. That is, the condition may provide an indication of a course of action that may be adopted by the UE to resolve the registration failure in order to successfully register the UE on the wireless network.

At 415, the UE may identify or otherwise determine whether a range of T3511 timer durations, N values (e.g., a range of the quantity of retry attempts), or T3502 timer durations, have been configured for the UE. That is, in some examples the UE may receive or otherwise obtain a configuration message that identifies a range of quantities of registration request retry messages or a range of durations between transmissions within the set of registration request retry message. Regarding the T3502 timer duration, the UE may receive the configuration message that identifies a range of second durations (e.g., a range of T3502 duration values) that are relative to a transmission of a last registration request retry message in the set of registration request retry messages. The second duration (e.g., the T3502 timer duration) may be used to start a new registration procedure by the UE when the transmissions of the set of registration request retry messages are unsuccessful (e.g., each transmission is associated with a registration failure).

In some aspects, method 400 illustrates a non-limiting example where the network may configure or otherwise provide the UE with a range of values based, at least in part, on their own (e.g., from the perspective of the network) data collection and/or knowledge of the network deployment. For example, the network may provide the UE with a range of values for the T3511 timer, the T3502 timer, and the quantity of retry attempts. The UE, when so configured, may select the quantity of registration request retry messages in the set as well as the duration between transmissions within the set of registration request retry messages from within these ranges and based on the condition associated with the UE.

Thus, in some examples the UE may be (pre) configured with a range of allowed values for the T3511 timer, the T3502 timer, and N retry attempts. For example, the UE may be (pre) configured with the range of values via a universal subscriber identity module (USIM) (e.g., a SIM card inserted into the UE), based on various UE policies associated with the UE, or via a device management parameter. These (pre) configured ranges may be used as default values if the UE does not receive any value from the network during the registration process. In some examples, the range of values may be provided by the network in a registration accept message or a registration reject message during the registration procedure. For example, the UE may receive or otherwise obtain a registration reject message within a registration timer (e.g., the T3510 timer) that carries or otherwise conveys the configuration message identifying the range of values. If the UE receives any range for any values from the network during the registration procedure, the UE may use that range over other (pre) configured or default values. In some aspects, the UE may use those values indicated during the registration procedure (e.g., over other (pre) configured or default values) where valid (e.g., while the UE is in that PLMN, using the same RAT, and the like).

In some aspects, if any range is/are (pre) configured or received for any of the value(s), the UE may select a value within the range provided by the network. In some aspects different ranges may be (pre) configured for different device types of the UE (e.g., RedCap UE vs. non-RedCap UE, IoT device vs. non-IoT device, and other device types). In some aspects, different ranges may be configured for different conditions associated with the UE. In some aspects, the three parameter ranges (e.g., the T3511 timer, the T3502 timer, and the N retry attempt ranges) may be configured for the UE per-PLMN, per-PLMN and RAT, per-registration area, or per-tracking area or tracking area list associated with the UE. For example, the configuration message may identify multiple ranges of quantities (e.g., multiple Ns) and multiple range of durations (e.g., multiple T3511 timer ranges or multiple T3502 timer ranges) where the different ranges may be based on the device type of the UE, based on different conditions associated with the UE, per-PLMN, and the like.

In some aspects, the different ranges may be provided in a secure manner to the UE. For example, the ranges may be provided in a USIM or any other secure memory associated with the UE. If provided by the network, these parameters (e.g., ranges) may be provided after mutual authentication and secure establishment in an integrity protected message (e.g., the registration accept message or the registration reject message). In some examples, the UE may ignore any of these parameters (e.g., ranges) if they are received in a non-integrity protected message. Accordingly, in some aspects the configuration message may be received based on a completion of a security and authentication establishment procedure associated with the UE.

Accordingly and when the UE is (pre) configured with the range of values for the T3511 timer, the T3502 timer, or the N retry attempt counter, at 420 the UE may select the quantity of registration request retry message in the set of registration request retry messages (e.g., the N retry attempt value), the duration between transmissions within the set of registration request retry messages (e.g., the T3511 timer), and the second duration relative to the transmission of the last registration request retry message in the set (e.g., the T3502 timer) from the (pre) configured ranges. The UE may select these values from within the ranges based on the condition associated with the UE.

However, when the UE has not been (pre) configured with these ranges, at 425 the UE may autonomously select the quantity of registration request retry message in the set of registration request retry messages (e.g., the N retry attempt value), the duration between transmissions within the set of registration request retry messages (e.g., the T3511 timer), and the second duration relative to the transmission of the last registration request retry message in the set (e.g., the T3502 timer). The UE may select these values based on the condition associated with the UE.

At 430, the UE may transmit the set of registration request retry messages based on the registration failure. The UE may transmit the set of registration request retry messages according to the selected T3511 timer duration, the N retry attempt value, and, when applicable, the T3502 timer duration value.

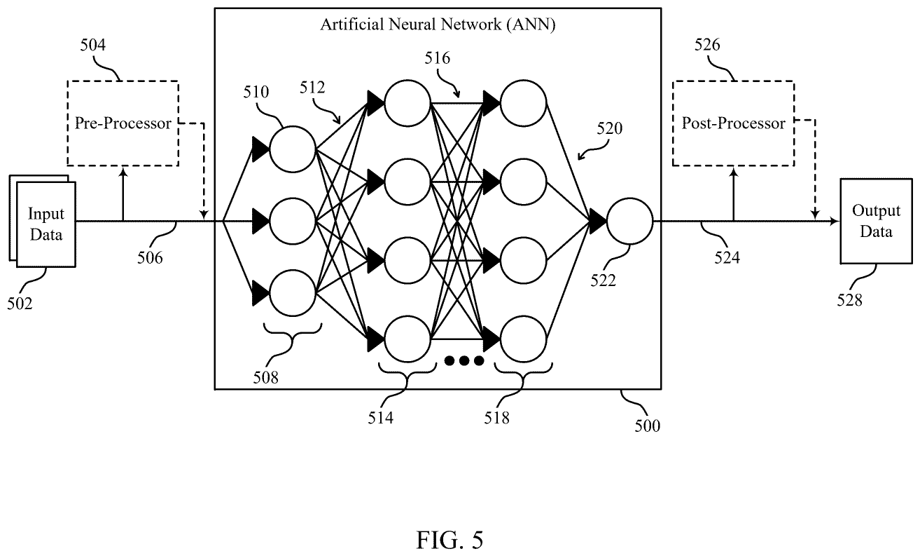

FIG. 5 is an illustrative block diagram of an example machine learning (ML) model represented by an artificial neural network (ANN) 500.

ANN 500 may receive input data 506 which may include one or more bits of data 502, pre-processed data output from pre-processor 504 (optional), or some combination thereof. Here, data 502 may include training data, verification data, application-related data, or the like, based, for example, on the stage of deployment of ANN 500. Pre-processor 504 may be included within ANN 500 in some other implementations. Pre-processor 504 may, for example, process all or a portion of data 502 which may result in some of data 502 being changed, replaced, deleted, etc. In some implementations, pre-processor 504 may add additional data to data 502. In some implementations, the pre-processor 504 may be a ML model, such as an ANN. In some aspects, pre-processor 504 may be employed or otherwise support determination of the quantity of registration request retry messages, the duration between transmissions within the set of registration request retry messages, or both, based on the condition detected by or otherwise associated with the UE.

ANN 500 includes at least one first layer 508 of artificial neurons 510 to process input data 506 and provide resulting first layer data via connections or “edges” such as edges 512 to at least a portion of at least one second layer 514. Second layer 514 processes data received via edges 512 and provides second layer output data via edges 516 to at least a portion of at least one third layer 518. Third layer 518 processes data received via edges 516 and provides third layer output data via edges 520 to at least a portion of a final layer 522 including one or more neurons to provide output data 524. All or part of output data 524 may be further processed in some manner by (optional) post-processor 526. Thus, in certain examples, ANN 500 may provide output data 528 that is based on output data 524, post-processed data output from post-processor 526, or some combination thereof.

Post-processor 526 may be included within ANN 500 in some other implementations. Post-processor 526 may, for example, process all or a portion of output data 524 which may result in output data 528 being different, at least in part, to output data 524, as result of data being changed, replaced, deleted, etc. In some implementations, post-processor 526 may be configured to add additional data to output data 524. In this example, second layer 514 and third layer 518 represent intermediate or hidden layers that may be arranged in a hierarchical or other like structure. Although not explicitly shown, there may be one or more further intermediate layers between the second layer 514 and the third layer 518. In some implementations, the post-processor 526 may be a ML model, such as an ANN. In some aspects, post-processor 526 may be employed or otherwise support determination of the quantity of registration request retry messages, the duration between transmissions within the set of registration request retry messages, or both, based on the condition detected by or otherwise associated with the UE.

The structure and training of artificial neurons 510 in the various layers may be tailored to specific requirements of an application. Within a given layer such as first layer 508, second layer 514, or third layer 518 of ANN 500, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of ANN 500. The weights and biases of ANN 500 may be adjusted during a training process or during operation of ANN 500. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 506. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 500, may be conducted using training data. Training data may include one or more datasets which ANN 500 may use to identify patterns or relationships. Training data may represent various types of information, including written, visual, audio, environmental context, operational properties, etc. During training, the parameters (such as the weights and biases) of artificial neurons 510 may be changed, such as to minimize or otherwise reduce a loss function or a cost function. A training process may be repeated multiple times to fine-tune ANN 500 with each iteration. In some aspects, the training data may relate to various conditions associated with a UE. For example, one or more datasets may be trained for each condition associated with the UE, such as high RSRP condition, low SINR condition, and the like. The datasets may contain parameters associated with the conditions as well as various performance characteristics of the UE associated with each condition. For example, the parameters may include various channel performance characteristics associated with the UE, a throughput level associated with the condition, a connection state or likelihood associated with the condition, and the like. In some aspects, the datasets may further include parameters related to different timer lengths and registration request retry attempts for various conditions. For example, the datasets may store or otherwise maintain a history of different values for the T3502 timers, the T3511 timers, and the retry attempt counters used when the UE is experiencing various conditions. The UE may use the training datasets to select such timer values when the UE is experiencing certain conditions and has detected a registration request failure.

ANN 500 or other ML models may be implemented in various types of processing circuits along with memory and applicable instructions therein. For example, general-purpose hardware circuits, such as, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed. In some implementations, the ML model may be implemented by a NPU or a TPU embedded in a system on chip (SoC) along with other components, such as one or more CPUs, GPUs, etc. A SoC includes several components manufactured on a shared semiconductor substrate. The NPU or TPU may be controlled by the one or more CPUs by configuring the ML model implemented by the NPU or TPU with weights and biases, providing certain training data to the ML model to configure the ML model, or providing input data to the ML model to obtain related inferences. The one or more CPUs may also receive the inferences and be configured to perform certain actions based on the inferences produced by the ML model. The actions performed by the one or more CPUs may include sending commands to other components of the SoC or components external to the SoC to perform certain actions. For example, the CPU may send commands to a RF transceiver based on the outputs or inferences obtained from an ML model to cause the RF transceiver to operate on a wireless network in accordance with the ML model.

In example aspects, an ML model may be trained prior to, or at some point following, operation of the ML model, such as ANN 500, on input data. When training the ML model, information in the form of applicable training data may be gathered or otherwise created for use in training an ANN accordingly. For example, training data may be gathered or otherwise created regarding information associated with received/transmitted signal strengths, interference, various conditions experienced by a UE when attempting to register with a network entity, different timer values or registration request retry attempt counters during a registration procedure, resource usage data, as well as any other relevant data that might be useful for training a model to address one or more problems or issues in a communication system, such as a registration procedure between a UE and a network entity. In certain instances, all or part of the training data may originate in a UE or other device in a wireless communication system, or one or more network entities, or aggregated from multiple sources (such as a UE and a network entity/entities, one or more other UEs, the Internet, or the like). For example, wireless network architectures, such as self-organizing networks (SON) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to registration procedures between a UE and network entity, identification and selection of T3502 timer values, T3511 timer values, as well as the number or quantity of registration request retry attempts (e.g., N) performed by the UE in the event of a registration request failure, etc. In some implementations, model deployment may occur jointly or separately at various network levels, such as, a UE, a network entity such as a base station, or a disaggregated network entity such as a central unit (CU), a distributed unit (DU), a radio unit (RU), or the like.

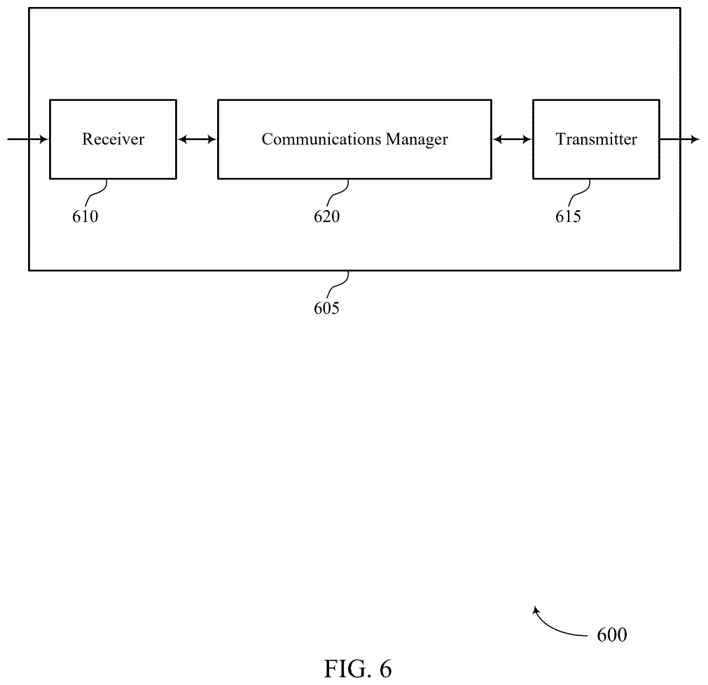

FIG. 6 shows a block diagram 600 of a device 605 that supports flexible recovery from registration procedure failure in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to flexible recovery from registration procedure failure). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to flexible recovery from registration procedure failure). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of flexible recovery from registration procedure failure as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for transmitting a registration request to a network entity that requests registration of the UE on a wireless network associated with the network entity. The communications manager 620 is capable of, configured to, or operable to support a means for detecting a registration failure associated with the registration request, the registration failure being associated with a condition associated with the UE. The communications manager 620 is capable of, configured to, or operable to support a means for transmitting a set of registration request retry messages based on the registration failure, where at least one of a quantity of registration request retry messages in the set of registration request retry messages or a duration between transmissions within the set of registration request retry messages is based on the condition associated with the UE.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for UE selection of T3511 timer, T3502 timer, and N retry attempt durations and values based on condition(s) observed or otherwise detected by the UE. In some aspects, the network may configure a range of such duration and value ranges for the UE and the UE may select from within the (pre) configured duration and value ranges based on the condition associated with the UE.

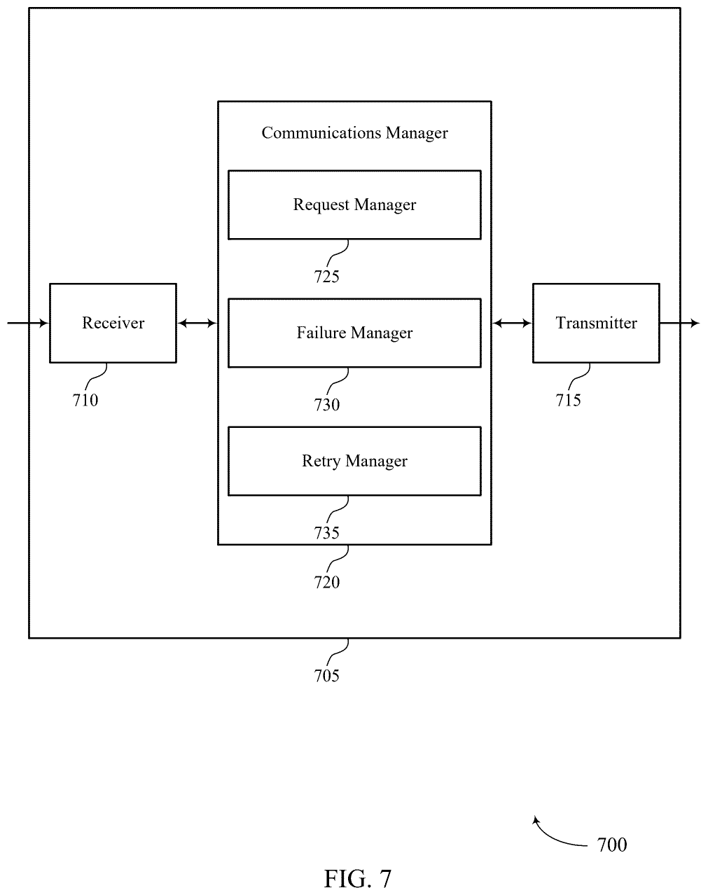

FIG. 7 shows a block diagram 700 of a device 705 that supports flexible recovery from registration procedure failure in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to flexible recovery from registration procedure failure). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to flexible recovery from registration procedure failure). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of flexible recovery from registration procedure failure as described herein. For example, the communications manager 720 may include a request manager 725, a failure manager 730, a retry manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The request manager 725 is capable of, configured to, or operable to support a means for transmitting a registration request to a network entity that requests registration of the UE on a wireless network associated with the network entity. The failure manager 730 is capable of, configured to, or operable to support a means for detecting a registration failure associated with the registration request, the registration failure being associated with a condition associated with the UE. The retry manager 735 is capable of, configured to, or operable to support a means for transmitting a set of registration request retry messages based on the registration failure, where at least one of a quantity of registration request retry messages in the set of registration request retry messages or a duration between transmissions within the set of registration request retry messages is based on the condition associated with the UE.

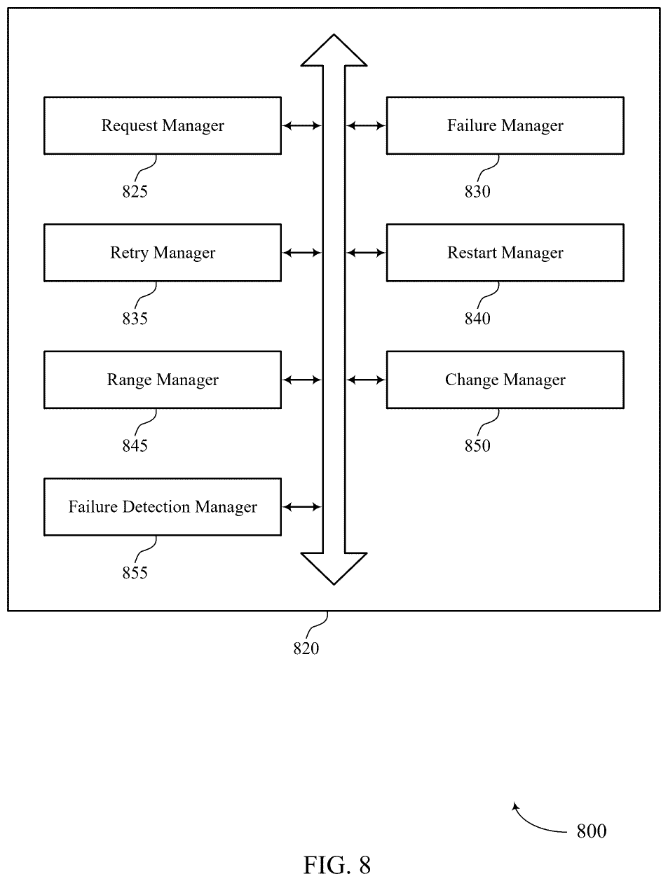

FIG. 8 shows a block diagram 800 of a communications manager 820 that supports flexible recovery from registration procedure failure in accordance with one or more aspects of the present disclosure. The communications manager 820 may be an example of aspects of a communications manager 620, a communications manager 720, or both, as described herein. The communications manager 820, or various components thereof, may be an example of means for performing various aspects of flexible recovery from registration procedure failure as described herein. For example, the communications manager 820 may include a request manager 825, a failure manager 830, a retry manager 835, a restart manager 840, a range manager 845, a change manager 850, a failure detection manager 855, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The request manager 825 is capable of, configured to, or operable to support a means for transmitting a registration request to a network entity that requests registration of the UE on a wireless network associated with the network entity. The failure manager 830 is capable of, configured to, or operable to support a means for detecting a registration failure associated with the registration request, the registration failure being associated with a condition associated with the UE. The retry manager 835 is capable of, configured to, or operable to support a means for transmitting a set of registration request retry messages based on the registration failure, where at least one of a quantity of registration request retry messages in the set of registration request retry messages or a duration between transmissions within the set of registration request retry messages is based on the condition associated with the UE.

In some examples, the restart manager 840 is capable of, configured to, or operable to support a means for starting a new registration procedure based on a second duration relative to transmission of a last registration request retry message in the set of registration request retry messages, where the second duration is based on the condition associated with the UE. In some examples, the restart manager 840 is capable of, configured to, or operable to support a means for receiving a configuration message identifying a range of second durations, where the second duration is selected by the UE from within the range of second durations.

In some examples, the range manager 845 is capable of, configured to, or operable to support a means for receiving a configuration message identifying at least one of a range of quantities of the registration request retry messages or a range of durations between transmissions within the set of registration request retry messages, where the quantity of registration retry messages is selected by the UE from within the range of quantities or the duration between transmissions within the set of registration request retry messages is selected by the UE from within the range of durations.

In some examples, the configuration message is associated with at least one of a USIM, a policy associated with the UE, or a device management parameter. In some examples, to support detecting the registration failure, the range manager 845 is capable of, configured to, or operable to support a means for receiving a registration request reject message within a registration timer duration based on registration request, where the configuration message is included in the registration request reject message. In some examples, the configuration message identifies multiple ranges of quantities and multiple ranges of durations, each range in the multiple ranges of quantities and multiple ranges of durations associated with a corresponding condition associated with the UE. In some examples, the configuration message is received based on a completion of a security and authentication establishment procedure associated with the UE.

In some examples, the restart manager 840 is capable of, configured to, or operable to support a means for starting a new registration procedure based on the transmission of the set of registration request retry messages being completed and expiration of a second duration.

In some examples, the condition associated with the UE includes at least one of a type of the UE, a battery status of the UE, a current network condition, a network operator associated with the UE, a tracking area of the UE, a cell identifier of a cell associated with the UE, a location of the UE, a user preference associated with the UE, a data need associated with the UE, a data latency associated with the UE, a RAT associated with the UE, or a registration area associated with the UE. In some examples, detecting the registration failure associated with the registration request is further associated with at least one of an artificial intelligence model or a machine learning model associated with the UE.

In some examples, the duration between transmissions within the set of registration request retry messages includes a first duration between a first set of successive transmissions. In some examples, a second duration between a second set of successive transmissions within the set of registration request retry messages is different than the first duration.

In some examples, the change manager 850 is capable of, configured to, or operable to support a means for ceasing remaining transmissions of the set of registration request retry messages based on at least one of a different network operator becoming available for a registration procedure with the UE or an emergency service requirement associated with the UE. In some examples, the change manager 850 is capable of, configured to, or operable to support a means for resetting the quantity of registration request retry messages based on at least one of a different network operator becoming available for a registration procedure with the UE or an emergency service requirement associated with the UE.

In some examples, to support detecting the registration failure, the failure detection manager 855 is capable of, configured to, or operable to support a means for receiving a registration request reject message within a registration timer duration after transmission of the registration request. In some examples, to support detecting the registration failure, the failure detection manager 855 is capable of, configured to, or operable to support a means for detecting a failure to receive a registration request reject message within a registration timer duration after transmission of the registration request.

In some examples, to support detecting the registration failure, the failure detection manager 855 is capable of, configured to, or operable to support a means for receiving an RRC message identifying a failure to register the UE according to the registration request.

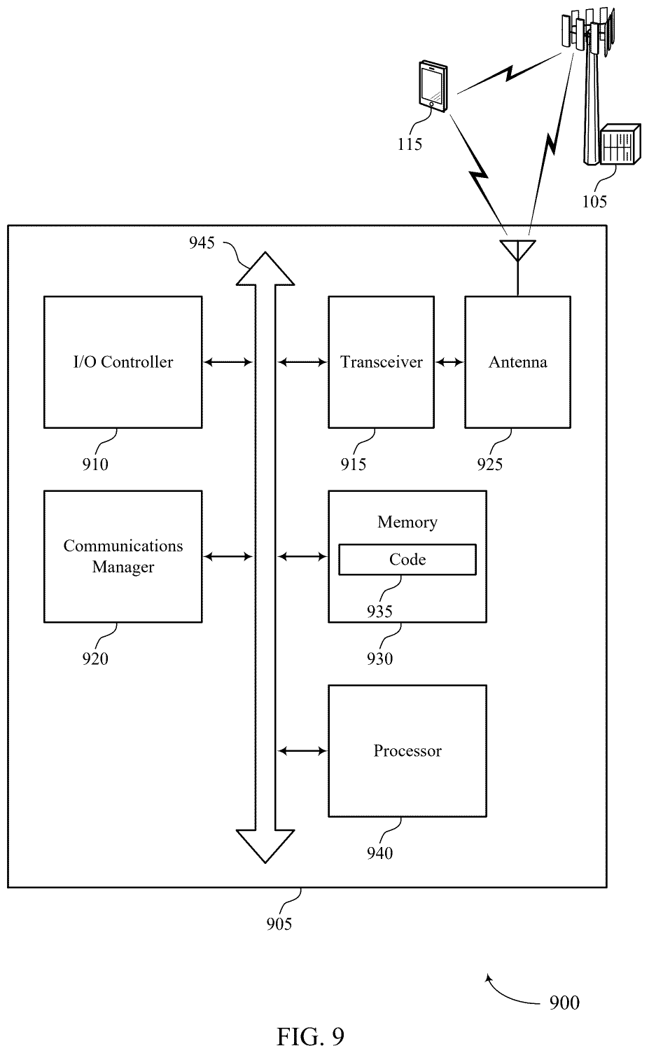

FIG. 9 shows a diagram of a system 900 including a device 905 that supports flexible recovery from registration procedure failure in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting flexible recovery from registration procedure failure). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 9840) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for transmitting a registration request to a network entity that requests registration of the UE on a wireless network associated with the network entity. The communications manager 920 is capable of, configured to, or operable to support a means for detecting a registration failure associated with the registration request, the registration failure being associated with a condition associated with the UE. The communications manager 920 is capable of, configured to, or operable to support a means for transmitting a set of registration request retry messages based on the registration failure, where at least one of a quantity of registration request retry messages in the set of registration request retry messages or a duration between transmissions within the set of registration request retry messages is based on the condition associated with the UE.

By including or configuring the communications manager 920 in accordance with examples as described herein, the device 905 may support techniques for UE selection of T3511 timer, T3502 timer, and N retry attempt durations and values based on condition(s) observed or otherwise detected by the UE. In some aspects, the network may configure a range of such duration and value ranges for the UE and the UE may select from within the (pre) configured duration and value ranges based on the condition associated with the UE.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of flexible recovery from registration procedure failure as described herein, or the at least one processor 940 and the at least one memory 930 may be otherwise configured to, individually or collectively, perform or support such operations.

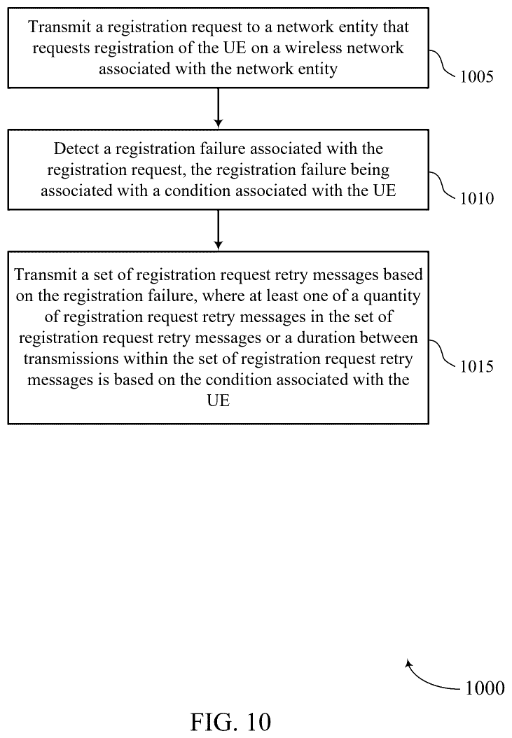

FIG. 10 shows a flowchart illustrating a method 1000 that supports flexible recovery from registration procedure failure in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include transmitting a registration request to a network entity that requests registration of the UE on a wireless network associated with the network entity. The operations of 1005 may be performed in accordance with examples as disclosed herein. In some examples, aspects of the operations of 1005 may be performed by a request manager 825 as described with reference to FIG. 8.

At 1010, the method may include detecting a registration failure associated with the registration request, the registration failure being associated with a condition associated with the UE. The operations of 1010 may be performed in accordance with examples as disclosed herein. In some examples, aspects of the operations of 1010 may be performed by a failure manager 830 as described with reference to FIG. 8.

At 1015, the method may include transmitting a set of registration request retry messages based on the registration failure, where at least one of a quantity of registration request retry messages in the set of registration request retry messages or a duration between transmissions within the set of registration request retry messages is based on the condition associated with the UE. The operations of 1015 may be performed in accordance with examples as disclosed herein. In some examples, aspects of the operations of 1015 may be performed by a retry manager 835 as described with reference to FIG. 8.

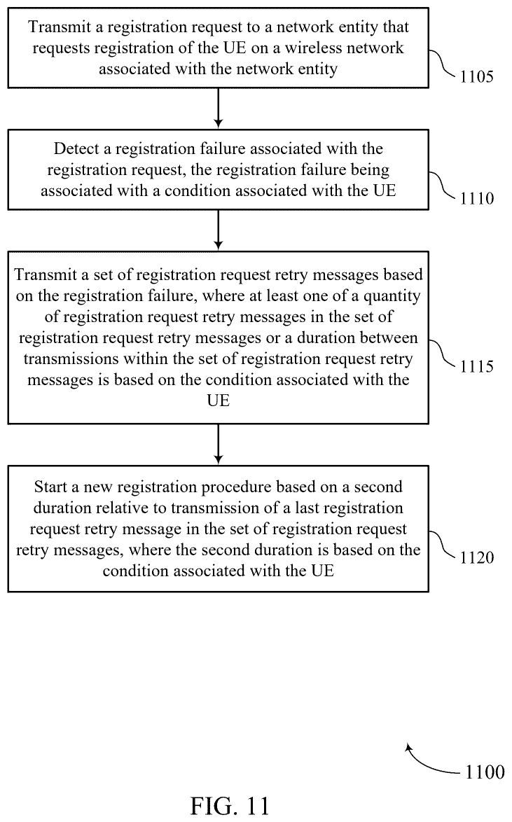

FIG. 11 shows a flowchart illustrating a method 1100 that supports flexible recovery from registration procedure failure in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include transmitting a registration request to a network entity that requests registration of the UE on a wireless network associated with the network entity. The operations of 1105 may be performed in accordance with examples as disclosed herein. In some examples, aspects of the operations of 1105 may be performed by a request manager 825 as described with reference to FIG. 8.

At 1110, the method may include detecting a registration failure associated with the registration request, the registration failure being associated with a condition associated with the UE. The operations of 1110 may be performed in accordance with examples as disclosed herein. In some examples, aspects of the operations of 1110 may be performed by a failure manager 830 as described with reference to FIG. 8.

At 1115, the method may include transmitting a set of registration request retry messages based on the registration failure, where at least one of a quantity of registration request retry messages in the set of registration request retry messages or a duration between transmissions within the set of registration request retry messages is based on the condition associated with the UE. The operations of 1115 may be performed in accordance with examples as disclosed herein. In some examples, aspects of the operations of 1115 may be performed by a retry manager 835 as described with reference to FIG. 8.

At 1120, the method may include starting a new registration procedure based on a second duration relative to transmission of a last registration request retry message in the set of registration request retry messages, where the second duration is based on the condition associated with the UE. The operations of 1120 may be performed in accordance with examples as disclosed herein. In some examples, aspects of the operations of 1120 may be performed by a restart manager 840 as described with reference to FIG. 8.

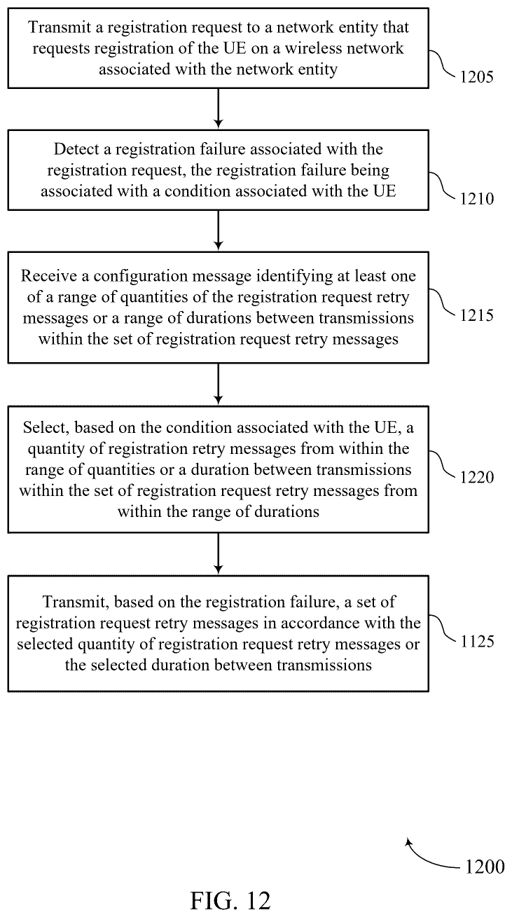

FIG. 12 shows a flowchart illustrating a method 1200 that supports flexible recovery from registration procedure failure in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include transmitting a registration request to a network entity that requests registration of the UE on a wireless network associated with the network entity. The operations of 1205 may be performed in accordance with examples as disclosed herein. In some examples, aspects of the operations of 1205 may be performed by a request manager 825 as described with reference to FIG. 8.

At 1210, the method may include detecting a registration failure associated with the registration request, the registration failure being associated with a condition associated with the UE. The operations of 1210 may be performed in accordance with examples as disclosed herein. In some examples, aspects of the operations of 1210 may be performed by a failure manager 830 as described with reference to FIG. 8.

At 1215, the method may include receiving a configuration message identifying at least one of a range of quantities of the registration request retry messages or a range of durations between transmissions within the set of registration request retry messages. The operations of 1215 may be performed in accordance with examples as disclosed herein. In some examples, aspects of the operations of 1215 may be performed by a range manager 845 as described with reference to FIG. 8.

At 1220, the method may include selecting, based on the condition associated with the UE, a quantity of registration retry messages from within the range of quantities or a duration between transmissions within the set of registration request retry messages from within the range of durations. The operations of 1220 may be performed in accordance with examples as disclosed herein. In some examples, aspects of the operations of 1220 may be performed by a retry manager 835 as described with reference to FIG. 8.

At 1225, the method may include transmitting, based on the registration failure, a set of registration request retry messages in accordance with the selected quantity of registration request retry messages or the selected duration between transmissions. The operations of 1225 may be performed in accordance with examples as disclosed herein. In some examples, aspects of the operations of 1225 may be performed by a retry manager 835 as described with reference to FIG. 8.

The following provides an overview of aspects of the present disclosure:

Aspect 1: A method for wireless communications at a UE, comprising: transmitting a registration request to a network entity that requests registration of the UE on a wireless network associated with the network entity; detecting a registration failure associated with the registration request, the registration failure being associated with a condition associated with the UE; and transmitting a set of registration request retry messages based at least in part on the registration failure, wherein at least one of a quantity of registration request retry messages in the set of registration request retry messages or a duration between transmissions within the set of registration request retry messages is based at least in part on the condition associated with the UE.

Aspect 2: The method of aspect 1, further comprising: starting a new registration procedure based at least in part on a second duration relative to transmission of a last registration request retry message in the set of registration request retry messages, wherein the second duration is based at least in part on the condition associated with the UE.

Aspect 3: The method of aspect 2, further comprising: receiving a configuration message identifying a range of second durations, wherein the second duration is selected by the UE from within the range of second durations.

Aspect 4: The method of any of aspects 1 through 3, further comprising: receiving a configuration message identifying at least one of a range of quantities of the registration request retry messages or a range of durations between transmissions within the set of registration request retry messages, wherein the quantity of registration retry messages is selected by the UE from within the range of quantities and the duration between transmissions within the set of registration request retry messages is selected by the UE from within the range of durations.

Aspect 5: The method of aspect 4, wherein the configuration message is associated with at least one of a USIM, a policy associated with the UE, or a device management parameter.

Aspect 6: The method of any of aspects 4 through 5, wherein detecting the registration failure comprises: receiving a registration request reject message within a registration timer duration based at least in part on registration request, wherein the configuration message is included in the registration request reject message.

Aspect 7: The method of any of aspects 4 through 6, wherein the configuration message identifies multiple ranges of quantities and multiple ranges of durations, each range in the multiple ranges of quantities and multiple ranges of durations associated with a corresponding condition associated with the UE.

Aspect 8: The method of any of aspects 4 through 7, wherein the configuration message is received based at least in part on a completion of a security and authentication establishment procedure associated with the UE.

Aspect 9: The method of any of aspects 1 through 8, further comprising: starting a new registration procedure based at least in part on the transmission of the set of registration request retry messages being completed and expiration of a second duration.

Aspect 10: The method of any of aspects 1 through 9, wherein the condition associated with the UE comprises at least one of a type of the UE, a battery status of the UE, a current network condition, a network operator associated with the UE, a tracking area of the UE, a cell identifier of a cell associated with the UE, a location of the UE, a user preference associated with the UE, a data need associated with the UE, a data latency associated with the UE, a RAT associated with the UE, or a registration area associated with the UE.

Aspect 11: The method of any of aspects 1 through 10, wherein, detecting the registration failure associated with the registration request is further associated with at least one of an artificial intelligence model or a machine learning model associated with the UE.

Aspect 12: The method of any of aspects 1 through 11, wherein the duration between transmissions within the set of registration request retry messages comprises a first duration between a first set of successive transmissions, and a second duration between a second set of successive transmissions within the set of registration request retry messages is different than the first duration.

Aspect 13: The method of any of aspects 1 through 12, further comprising: ceasing remaining transmissions of the set of registration request retry messages based on at least one of a different network operator becoming available for a registration procedure with the UE or an emergency service requirement associated with the UE.

Aspect 14: The method of any of aspects 1 through 13, further comprising: resetting the quantity of registration request retry messages based on at least one of a different network operator becoming available for a registration procedure with the UE or an emergency service requirement associated with the UE.

Aspect 15: The method of any of aspects 1 through 14, wherein detecting the registration failure comprises: receiving a registration request reject message within a registration timer duration based at least in part on the registration request.

Aspect 16: The method of any of aspects 1 through 15, wherein detecting the registration failure comprises: detecting a failure to receive a registration request reject message within a registration timer duration based at least in part on the registration request.

Aspect 17: The method of any of aspects 1 through 16, wherein detecting the registration failure comprises: receiving an RRC message identifying a failure to register the UE according to the registration request.

Aspect 18: A UE for wireless communications, comprising one or more memories storing processor-executable code, and one or more processors coupled with the one or more memories and individually or collectively operable to execute the code to cause the UE to perform a method of any of aspects 1 through 17.

Aspect 19: A UE for wireless communications, comprising at least one means for performing a method of any of aspects 1 through 17.

Aspect 20: A non-transitory computer-readable medium storing code for wireless communications, the code comprising instructions executable by one or more processors to perform a method of any of aspects 1 through 17.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a registration request to a network entity that requests registration of the UE on a wireless network associated with the network entity;
detect a registration failure associated with the registration request, the registration failure being associated with a condition associated with the UE; and
transmit a set of registration request retry messages based at least in part on the registration failure, wherein at least one of a quantity of registration request retry messages in the set of registration request retry messages or a duration between transmissions within the set of registration request retry messages is based at least in part on the condition associated with the UE.

2. The UE of claim 1, wherein the one or more processors are individually or collectively further operable to execute the code to cause the UE to:
start a new registration procedure based at least in part on a second duration relative to transmission of a last registration request retry message in the set of registration request retry messages, wherein the second duration is based at least in part on the condition associated with the UE.

3. The UE of claim 2, wherein the one or more processors are individually or collectively further operable to execute the code to cause the UE to:
receive a configuration message identifying a range of second durations, wherein the one or more processors are individually or collectively operable to execute the code to cause the UE to select the second duration from within the range of second durations.

4. The UE of claim 1, wherein the one or more processors are individually or collectively further operable to execute the code to cause the UE to:
receive a configuration message identifying at least one of a range of quantities of the registration request retry messages or a range of durations between transmissions within the set of registration request retry messages, wherein the one or more processors are individually or collectively operable to execute the code to cause the UE to select the quantity of registration retry messages from within the range of quantities or select the duration between transmissions within the set of registration request retry messages from within the range of durations.

5. The UE of claim 4, wherein the configuration message is associated with at least one of a universal subscriber identity module (USIM), a policy associated with the UE, or a device management parameter.

6. The UE of claim 4, wherein, to detect the registration failure, the one or more processors are individually or collectively operable to execute the code to cause the UE to:
receive a registration request reject message within a registration timer duration based at least in part on registration request, wherein the configuration message is included in the registration request reject message.

7. The UE of claim 4, wherein the configuration message identifies multiple ranges of quantities and multiple ranges of durations, each range in the multiple ranges of quantities and multiple ranges of durations associated with a corresponding condition associated with the UE.

8. The UE of claim 4, wherein the one or more processors are individually or collectively operable to execute the code to cause the UE to receive the configuration message based at least in part on a completion of a security and authentication establishment procedure associated with the UE.

9. The UE of claim 1, wherein the one or more processors are individually or collectively further operable to execute the code to cause the UE to:
start a new registration procedure based at least in part on the transmission of the set of registration request retry messages being completed and expiration of a second duration.

10. The UE of claim 1, wherein the condition associated with the UE comprises at least one of a type of the UE, a battery status of the UE, a current network condition, a network operator associated with the UE, a tracking area of the UE, a cell identifier of a cell associated with the UE, a location of the UE, a user preference associated with the UE, a data need associated with the UE, a data latency associated with the UE, a radio access technology (RAT) associated with the UE, or a registration area associated with the UE.

11. The UE of claim 1, wherein the one or more processors are individually or collectively operable to execute the code to cause the UE to detect the registration failure associated with the registration request in association with at least one of an artificial intelligence model or a machine learning model associated with the UE.

12. The UE of claim 1, wherein:
the duration between transmissions within the set of registration request retry messages comprises a first duration between a first set of successive transmissions, and
a second duration between a second set of successive transmissions within the set of registration request retry messages is different than the first duration.

13. The UE of claim 1, wherein the one or more processors are individually or collectively further operable to execute the code to cause the UE to:
cease remaining transmissions of the set of registration request retry messages based on at least one of a different network operator becoming available for a registration procedure with the UE or an emergency service requirement associated with the UE.

14. The UE of claim 1, wherein the one or more processors are individually or collectively further operable to execute the code to cause the UE to:
reset the quantity of registration request retry messages based on at least one of a different network operator becoming available for a registration procedure with the UE or an emergency service requirement associated with the UE.

15. The UE of claim 1, wherein, to detect the registration failure, the one or more processors are individually or collectively operable to execute the code to cause the UE to:
receive a registration request reject message within a registration timer duration after transmission of the registration request.

16. The UE of claim 1, wherein, to detect the registration failure, the one or more processors are individually or collectively operable to execute the code to cause the UE to:
detect a failure to receive a registration request reject message within a registration timer duration after transmission of the registration request.

17. The UE of claim 1, wherein, to detect the registration failure, the one or more processors are individually or collectively operable to execute the code to cause the UE to:
receive a radio resource control (RRC) message identifying a failure to register the UE according to the registration request.

18. A method for wireless communications at a user equipment (UE), comprising:
transmitting a registration request to a network entity that requests registration of the UE on a wireless network associated with the network entity;
detecting a registration failure associated with the registration request, the registration failure being associated with a condition associated with the UE; and
transmitting a set of registration request retry messages based at least in part on the registration failure, wherein at least one of a quantity of registration request retry messages in the set of registration request retry messages or a duration between transmissions within the set of registration request retry messages is based at least in part on the condition associated with the UE.

19. The method of claim 18, further comprising:
starting a new registration procedure based at least in part on a second duration relative to transmission of a last registration request retry message in the set of registration request retry messages, wherein the second duration is based at least in part on the condition associated with the UE.

20. A non-transitory computer-readable medium storing code for wireless communications at a user equipment (UE), the code comprising instructions executable by one or more processors to:
transmit a registration request to a network entity that requests registration of the UE on a wireless network associated with the network entity;
detect a registration failure associated with the registration request, the registration failure being associated with a condition associated with the UE; and
transmit a set of registration request retry messages based at least in part on the registration failure, wherein at least one of a quantity of registration request retry messages in the set of registration request retry messages or a duration between transmissions within the set of registration request retry messages is based at least in part on the condition associated with the UE.
